(19) United States
(12) Patent Application Publication
(10) Pub. No.: US 2026/0261316 A1
(43) Pub. Date: Sep. 3, 2026

(54) METHODS FOR COMMUNICATION, TERMINAL DEVICE, NETWORK DEVICE AND COMPUTER READABLE MEDIUM

(71) Applicant: NEC Corporation, Tokyo (JP)

(72) Inventors: Gang WANG, Beijing (CN); Yukai GAO, Beijing (CN); Peng GUAN, Beijing (CN)

(73) Assignee: NEC Corporation, Tokyo (JP)

(21) Appl. No.: 18/993,367

(22) PCT Filed: Jul. 13, 2022
(86) PCT No.: PCT/CN2022/105570

§ 371 Date: Jan. 10, 2025

(51) Int. Cl. H04B 7/06; H04W 24/10

(52) U.S. Cl. CPC H04B 7/063; H04W 24/10

(57) ABSTRACT

Example embodiments of the present disclosure relate to methods for communication, a terminal device, a network device and a computer readable medium. In an example method, the terminal device may determine beam information of a first number of beams predicted by an artificial intelligence (AI) model, and the terminal device may generate a beam report including a first indication of the first number and the beam information of a second number of the predicted beams among the first number of the predicted beams, and then the terminal device may transmit the beam report to a network device. In this way, it is helpful for the network device and the terminal device to determine the optimal beam(s), and it is also helpful to determine the generalization performance of the AI model.

### FIELD

Embodiments of the present disclosure generally relate to the field of communication techniques, and in particular, to methods for communication, a terminal device, a network device and a computer readable medium.

### BACKGROUND

In the communication technology, there is a constant evolution ongoing in order to provide efficient and reliable solutions for utilizing wireless communication networks. Each new generation has its own technical challenges for handling different situations and processes that are needed to connect and serve devices connected to wireless networks. To meet the demand for wireless data traffic having increased since deployment of 4th generation (4G) communication systems, efforts have been made to develop an improved 5th generation (5G) or pre-5G communication system. The new communication systems can support various types of service applications for terminal devices.

For AI/MI (Artificial intelligence/Machine learning)-based beam management, support BM (Beam management)-Case1 (Spatial-domain DL beam prediction for Set A of beams based on measurement results of Set B of beams) and BM-Case2 (Temporal DL beam prediction for Set A of beams based on the historic measurement results of Set B of beams) for characterization and baseline performance evaluations. BM-Case1 and BM-Case2 respectively based on classification and regression. However, various aspects of schemes related to the AI/MI-based beam need to be further studied and improved.

### SUMMARY

In general, example embodiments of the present disclosure provide methods for communication, a terminal device, a network device and a computer readable medium.

In a first aspect, there is provided a method for communication. The method comprises: determining, at a terminal device, beam information of a first number of beams predicted by an artificial intelligence (AI) model; generating, a beam report including a first indication of the first number and the beam information of a second number of the predicted beams among the first number of the predicted beams; and transmitting the beam report to a network device.

In a second aspect, there is provided a method for communication. The method comprises: determining, at a terminal device, beam information of a first number of beams predicted by an artificial intelligence (AI) model; generating, a beam report including the beam information of a second number of the predicted beams among the first number of the predicted beams and a second indication indicating whether the first number is larger than, less than or equal to a value of the number of beams to be reported by the terminal device configured by the network device; and transmitting the beam report to a network device.

In a third aspect, there is provided a method of communication. The method comprises: receiving, at a network device from a terminal device, a beam report including a first indication of a first number and beam information of a second number of the predicted beams among the first number of the predicted beams, the predicted beams being predicted by an artificial intelligence (AI) model; and processing the beam report.

In a fourth aspect, there is provided a method for communication. The method comprises: receiving, at a network device from a terminal device, a beam report including beam information of a second number of predicted beams among a first number of predicted beams predicted by an artificial intelligence (AI) model and a second indication indicating whether the first number is larger than, less than or equal to a value of the number of beams to be reported by the terminal device configured by the network device; and processing the beam report.

In a fifth aspect, there is provided a terminal device. The terminal device comprises: a processor; and a memory storing computer program codes; the memory and the computer program codes configured to, with the processor, cause the terminal device to perform the method according to the first aspect above.

In a sixth aspect, there is provided a network device. The network device comprises: a processor; and a memory storing computer program codes; the memory and the computer program codes configured to, with the processor, cause the network device to perform the method according to the second aspect above.

In a seventh aspect, there is provided a computer readable medium having instructions stored thereon, the instructions, when executed on at least one processor, causing the at least one processor to carry out the method according to the first aspect or the second aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates a schematic diagram illustrating a process for communication between a terminal device and a network device;

FIG. 3 illustrates an example of an AI model for predicting a best beam;

FIG. 4 illustrates another example of an AI model for predicting a best beam;

FIG. 5 illustrates a further example of an AI model for predicting a best beam;

FIG. 6 illustrates a still further example of an AI model for predicting a best beam;

FIG. 7 illustrates an example of a schematic diagram of beam report composition;

FIG. 8 illustrates another example of a schematic diagram of beam report composition;

FIG. 9 illustrates an example of a signaling chart for beam reporting between a terminal device and a network device;

FIG. 10 illustrates another example of a signaling chart for beam reporting between a terminal device and a network device;

FIG. 11 illustrates a further example of a signaling chart for beam reporting between a terminal device and a network device;

FIG. 12 illustrates a still further example of a signaling chart for beam reporting between a terminal device and a network device;

FIG. 13 illustrates a yet further example of a signaling chart for beam reporting between a terminal device and a network device;

FIG. 14 illustrates a schematic diagram illustrating a process for communication between a terminal device and a network device;

FIG. 15 illustrates an example of a signaling chart for beam reporting between a terminal device and a network device; and

FIG. 16 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

Principles and implementations of the present disclosure will be described in detail below with reference to the figures. According to [R1-2205454, Discussion summary #4 for other aspects on AI/MI (Artificial intelligence/Machine learning) for BM], the following potential spec impacts are to be studied: (1) New or enhanced mechanism(s) to facilitate data collection for UE/NW (Network) model, e.g., training, fine-tuning, verification, e.g., some examples are mentioned by contributions: Enhanced BM procedures (including signaling/configuration, reporting) to facilitate the training data collection; Introduction of some new information, e.g., UE positioning, information from sensor (e.g., velocity, orientation, rotation); Other assistance information for training; (2) New or enhanced mechanism(s) to facilitate AI/MI inference, e.g., some examples are mentioned by reporting contributions: Enhanced BM measurement/for AI inference; Signaling/configuration for enhanced BM measurement/reporting; Assistance information for AI inference; (3) New or enhanced mechanism(s) to facilitate AI model life cycle management, e.g., some examples are mentioned by contributions: Mechanisms/assistance information for AI/MI model activation, deactivation; Mechanisms/assistance information for AI model selection; Mechanisms/assistance information for Performance monitoring; May include the exchange of some assistance information; (4) AI-related UE capability and reporting; (5) Interface of AI model, e.g., input, output, and (6) other enhancements.

According to RAN1 #109-e [Chair's notes RAN1 #109-e v15] For AI/MI-based beam management, support BM-Case1 and BM-Case2 for characterization and baseline performance evaluations. BM-Case1: Spatial-domain DL beam prediction for Set A of beams based on measurement results for Set B of beams. BM-Case2: Temporal DL beam prediction for Set A of beams based on the historic measurement results of Set B of beams. For BM-Case1 and BM-Case2, Beams in Set A and Set B can be in the same Frequency Range.

According to RAN1 #109-e [Chair's notes RAN1 #109-e v15], and [R1-2205454, Discussion summary #4 for other aspects on AI/ML for beam management]. For the sub case BM-Case1, consider two alternative for further study, the first alternative is that the Set B is a subset of the Set A, the number of beams in the Set A and the Set B, and how to determine the Set B out of the beams in the Set A (e.g., fixed pattern, random patter, etc.) can be studied; the second alternative is that Set A and Set B are different (e.g. Set A consists of narrow beams and Set B consists of wide beams), the number of beams in the Set A and the Set B, and QCL (Quasi-co location) relation between beams in Set A and beams in Set B. Set A is for DL beam prediction and Set B is for DL beam measurement. The narrow and wide beam terminology is for SI discussion only and has no specification impact. The codebook constructions of Set A and Set B can be clarified by the companies.

For the sub use case BM-Case1, consider both Alt.1 and Alt.2 for further study: Alt.1: AI/ML inference at NW side, Alt.2: AI/ML inference at UE side. According to RAN1 #109-e [Chair's notes RAN1 #109-e v15], as for the input of AI model, regarding the sub use case BM-Case1, further study the following alternatives for AI/ML input: Alt.1: Only L1-RSRP measurement based on Set B. Alt.2: L1-RSRP measurement based on Set B and assistance information. The following were mentioned by companions in the discussion: Tx and/or Rx beam shape information (e.g., Tx and/or Rx beam pattern, Tx and/or Rx beam boresight direction (azimuth and elevation), 3 dB beamwidth, etc.), expected Tx and/or Rx beam for the prediction (e.g., expected Tx and/or Rx angle, Tx and/or Rx beam ID (CRI or SSBRI) for the prediction), UE position information, UE direction information, Tx beam usage information, UE orientation information, etc. The provision of assistance information may be infeasible due to the concern of disclosing proprietary information to the other side. Alt.3: CIR based on Set B. Alt.4: L1-RSRP measurement based on Set B and the corresponding DL Tx and/or Rx beam ID. It is up to companies to provide other alternative(s) including the combination of some alternatives. All the inputs are “nominal” and only for discussion purpose.

According to RAN1 #109-e [R1-2205454, Discussion summary #4 for other aspects on AI/ML for beam management], as for the output of AI model, regarding the sub case BM-Case1, further study the following alternative for AI/ML output: Alt.1: Tx and/or Rx Beam ID(s) and/or the predicted L1-RSRP of the predicted Top-N1 DL Tx and/or Rx beams. How to select Top-N1 DL Tx and/or Rx beams (e.g., L1-RSRP higher than a threshold, a sum probability of being the best beams higher than a threshold). Alt.2: Tx and/or Rx beams ID(s) of the predicted Top-N1 DL Tx and/or Rx beams and other information (e.g., probability for the beam to be the best beam, an updated set B). Alt.3: the predicted RSRP corresponding to the Tx and/or Rx beam direction which is input to the model. Alt.4: Tx and/or Rx beam angle(s) and the predicted RSRP (optional) of the predicted Top-N1 DL Tx and/or Rx beams. It is up to companies to provide other alternative(s). Beam ID is only used for discussion purpose. All the outputs are “nominal” and only for discussion purpose. Values of N1 are up to each company.

As mentioned above, various aspects of schemes related to the AI/MI-based beam need to be further studied and improved. In order to solve at least these and potentially other technical problems in the art, example embodiments of the present disclosure provide some solutions for reporting beams predicted by an AI model. The example embodiments of the present disclosure can be helpful for a network device and a terminal device to determine the optimal beam(s), and can also be helpful to determine the generalization performance of the AI model. Principles and some example embodiments of the present disclosure will be described in detail below with reference to the accompanying drawings.

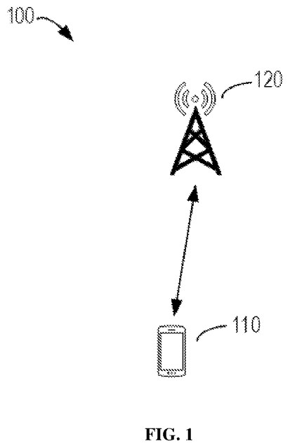

FIG. 1 illustrates an example communication system 100 in which some embodiments of the present disclosure can be implemented. The communication system 100, which is a part of a communication network, includes a network device 120 and a terminal device 110.

The network device 120 can provide services to the terminal device 110, and the network device 120 and the terminal device 110 may communicate data and control information with each other. In some embodiments, the network device 120 and the terminal device 110 may communicate with direct links/channels.

In the system 100, a link from the network devices 120 to the terminal device 110 is referred to as a downlink (DL), while a link from the terminal device 110 to the network devices 120 is referred to as an uplink (UL). In downlink, the network device 120 is a transmitting (TX) device (or a transmitter) and the terminal device 110 is a receiving (RX) device (or a receiver). In uplink, the terminal device 110 is a transmitting TX device (or a transmitter) and the network device 120 is a RX device (or a receiver). It is to be understood that the network device 120 may provide one or more serving cells. In some embodiments, the network device 120 can provide multiple cells.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices and their connection relationships and types shown in FIG. 1 are only for the purpose of illustration without suggesting any limitation. The communication system 100 may include any suitable numbers of devices adapted for implementing embodiments of the present disclosure. In some embodiments, the network device 120 can provide multiple cells.

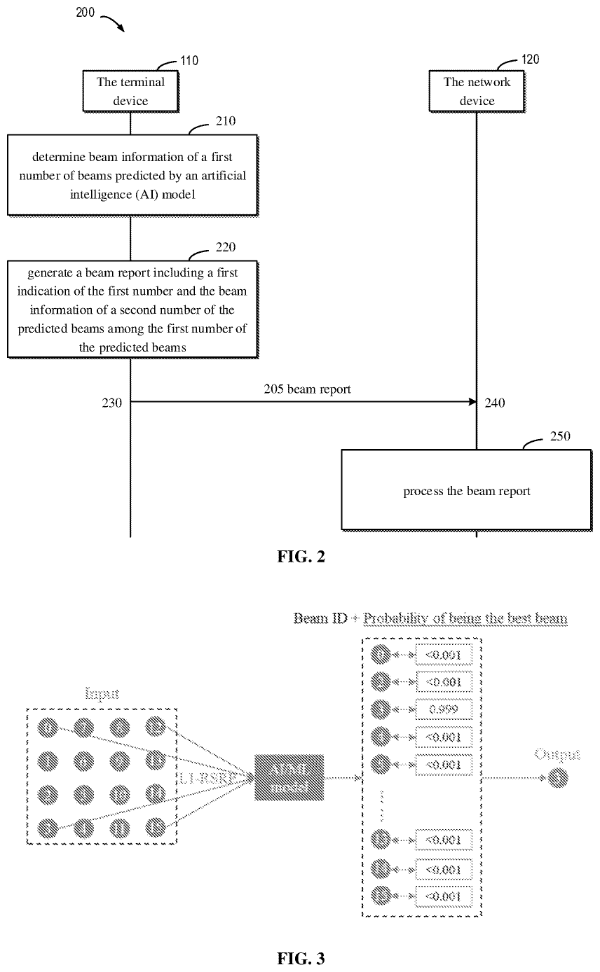

FIG. 2 illustrates a schematic diagram illustrating a process 200 of communication between a terminal device 110 and a network device 120. As shown in FIG. 2, at the terminal device 110, the terminal device 110 may determine (210) beam information of a first number of beams predicted by an artificial intelligence (AI) model, and the terminal device 110 may generate (220) a beam report (205) including a first indication of the first number and the beam information of a second number of the predicted beams among the first number of the predicted beams, and then the terminal device 110 may transmit (230) the beam report (205) to the network device 120.

At the network device 120, the network device 120 may receive (240) from the terminal device 110, the beam report (205) includes a first indication of a first number and beam information of a second number of the predicted beams among the first number of the predicted beams, the predicted beams may be predicted by an artificial intelligence (AI) model, and then the network device 120 may process (250) the beam report (205). In this way, it is helpful for the network device 120 and the terminal device 110 to determine the optimal beam(s), and it is also helpful to determine the generalization performance of the AI model.

In some embodiments, the beam report refers to CSI report carrying L1-RSRP, L1-SINR, CRI or SSBRI, or CSI report with report quantity of “cri-RSRP”, “ssb-Index-RSRP”, “cri-SINR” or “ssb-Index-SINR”, etc. Beam of a target signal refers to QCL-TypeD (source) reference signal of the target signal. Beam information refers to beam ID and corresponding beam quality. Beam ID refers to CRI or SSBRI. Beam quality refers to: L1-RSRP or L1-SINR. QCL-TypeD refers to the Spatial Rx parameters. In some embodiments, the AI model is used for predicting or outputting or inferring or determining one or more optimal beams.

In order to explain the scheme of the embodiment of the present disclosure more clearly, the AI model is first introduced below. FIG. 3 illustrates an example of an AI model for predicting a best beam. As shown in FIG. 3, the AI model predicts the best beam based on classification. For short, assuming that the input of the AI model is the L1-RSRPs (layer 1 reference signal received power) corresponding to the 4 beams (i.e., Set B), Set A consists of 16 beams. Set B is a set of beams or beam IDs as an input of the AI model. One or more beams (including beam IDs and beam qualities) outputted by the AI model comes from Set A. In addition, Set B may be a subset of Set A. In general, the AI model may be used for estimating one or more beams (e.g. one or more optimal beams) in Set A by using part of beams (i.e. Set B) in Set A. The AI model can obtain the probability (or weight ratio) of being the best beam corresponding to each beam (in Set A) first. Ideally or generally, as shown in FIG. 3, only one beam has the highest probability. Then the AI model can output the beam having the highest probability as the predicted best beam, i.e., top 1 beam out of Set A, as shown in FIG. 3, the highest probability is 0.999, and ID of beam outputted by the AI model is 3.

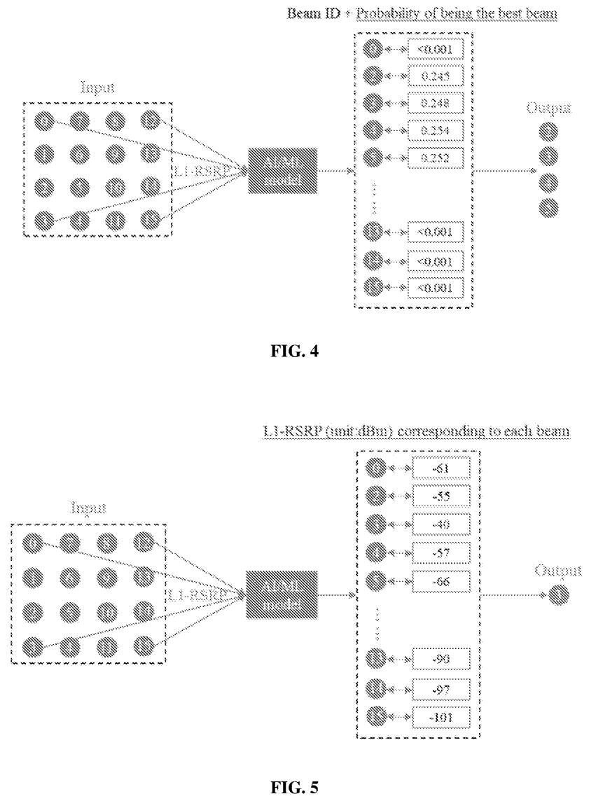

FIG. 4 illustrates another example of an AI model for predicting a best beam. As shown in FIG. 4, the AI model predicts the best beam based on classification. In some cases, for example, the actual qualities corresponding to multiple beams are close, and in some other cases, for example, the inference performance of an AI model in the current environment is poor, i.e., generalization performance is poor. The probabilities of being the best beam corresponding to multiple beams are close, and these probabilities are higher than the other probabilities obviously, so the AI model can output these beams as the predicted best beams, i.e., top 4 beams out of Set A, as shown in FIG. 4, ID of beams outputted by the AI model are 2, 3, 4 and 5.

FIG. 5 illustrates a further example of an AI model for predicting a best beam. As shown in FIG. 5, the AI model predicts the best beam based on regression. The AI model can estimate the L1-RSRPs corresponding to each beam (in Set A) first. Ideally or generally, as shown in FIG. 5, only one beam has the highest L1-RSRP (relatively obvious). Then the AI model can output the beam having the highest L1-RSRP as the predicted best beam, i.e., top 1 beam out of Set A, as shown in FIG. 5, ID of beam outputted by the AI model is 3.

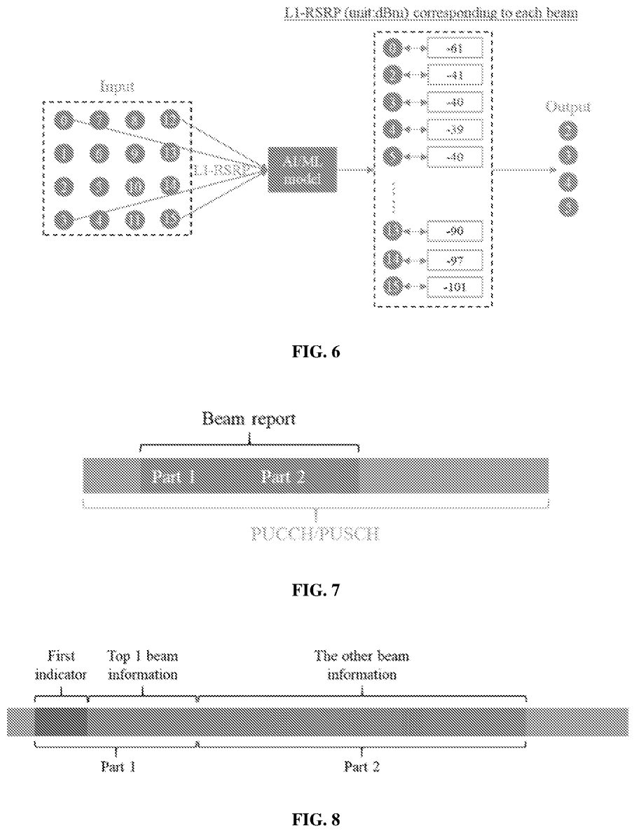

FIG. 6 illustrates a still further example of an AI model for predicting a best beam. As shown in FIG. 6, the AI model predicts the best beam based on regression. In some cases, for example, the actual qualities corresponding to multiple beams are close, and in some other cases, for example, the inference performance of the AI model in the current environment is poor, i.e., generalization performance is poor. The estimated L1-RSRPs corresponding to multiple beams are close, even consistent, and these L1-RSRPs are higher than the other L1-RSRPs obviously, so the AI model can output these beams as the predicted best beams, i.e., top 4 beams out of Set A, as shown in FIG. 6, ID of beams outputted by the AI model are 2, 3, 4 and 5.

With reference to the AI model in FIG. 3 to FIG. 6, the number of predicted beams outputted by AI model is unfixed, i.e., the value of N1 is unfixed and depends on AI model. The value of K depends on gNB's configuration. If AI model is deployed at gNB side, the value of N1 is determined by gNB. If N1>1, gNB can trigger a beam report for the predicted beams to determine the actual best beam. If AI model is deployed at UE side, the value of N1 is determined by UE. This may result in the following conditions: the first condition, N1=K, then it is OK. The second condition, N1> K, then it means that UE only report K beams out of N1 predicted beams outputted by AI model. But actually, the actual best beam may be any one out of the N1 predicted beams, e.g., may also be any one out of N1-K beams. Therefore, this method may cause gNB to fail to obtain the actual best beam. Additionally, even though this problem is tolerable, UE cannot determine what is causing N1>1, e.g., Case1 or Case2 mentioned previous. If Case1, it is OK. But if Case2, it should be intolerable.

In order to solve this problem, UE needs to report the N1 predicted beams to gNB. Then, gNB trigger a beam report (i.e., beam measurement and reporting) for the N1 predicted beams. The third condition, N1<K, e.g., N1=1 and K=4, it means that UE needs to report only one beam, but gNB reserves the resource for 4 beams. This may lead to waste of resources for beam reporting. In conclusion, if AI model is deployed at UE side, UE needs to report to gNB the N1 predicted beams outputted by AI model. It means that the number of beams to report should be unfixed, not fixed (i.e., depends on configured K). The embodiments of the present disclosure can solve the above problems. The following will be described in detail.

Some embodiments of the disclosure take UE as an example of the terminal device 110 and take gNB as an example of the network device 120. It should be noted that the terminal device 110 of the embodiment of the present disclosure is not limited to UE, and the network device 120 is not limited to gNB.

In some embodiments, the terminal device 110 may determine a payload size of the first indication based on the number of channel state information reference signal (CSI-RS) or synchronization signal and PBCH block (SSB) resources corresponding to the beam report. In some embodiments, the terminal device 110 may determine a payload size of the first indication based on a value of the number of beams to be reported by the terminal device 110 configured by the network device 120. In some embodiments, the value of the number of beams to be reported by the terminal device 110 configured by the network device 120 is determined by the network device 120 based on the capability information of the terminal device 110.

At the network device 120, in some embodiments, the network device 120 may receive the capability information of the terminal device 110, and may determine the value based on the capability information of the terminal device 110. Accordingly, at the network device 120, in some embodiments, the network device 120 may determine a payload size of the first indication based on the number of channel state information reference signal (CSI-RS) or synchronization signal and PBCH block (SSB) resources corresponding to the beam report.

In some embodiments, the network device 120 may determine a payload size of the first indication based on a value of the number of beams to be reported by the terminal device 110 configured by the network device 120. In some embodiments, the network device 120 may determine a payload size of the first indication based on capability information of the terminal device 110 indicating a maximum number of beams predicted by the AI model.

In some embodiments, the terminal device 110 may determine a payload size of the first indication based on capability information of the terminal device 110 indicating a maximum number of beams predicted by the AI model. In some embodiments, the beam report includes a first part and a second part, the first part includes the first indication, and the second part includes the beam information of the second number of the predicted beams.

As shown in FIG. 7, which illustrates an example of a schematic diagram of beam report composition, the beam report comprises of two parts, i.e. Part 1 and Part 2. The Part 1 contains at least an indication of the number of beams to report (or the number of beams outputted by the AI model), and the Part 2 contains at least beam information. In these embodiments, the terminal device 110 may determine the second number based on the first number indicated by the first indication.

With reference to FIG. 7, in some embodiments, a beam report on PUCCH/PUSCH comprises of two parts above. In some embodiments, the Part 1 has a fixed payload size (or bitwidth) and is used to identify the number of information bits in the Part 2. The Part 1 will be transmitted in its entirety before the Part 2. The Part1 contains an indication (called as “first indicator” for short) of the number of beams to report. Specifically, the first indicator refers to the number of beams to report in the beam report, or in the Part 2. Furthermore, the first indicator can also refer to the number of the predicted beams outputted by AI model.

Additionally, the number of beams to report can also be used to be a metric/quantity reflecting the performance of an AI model. The Part 2 has an unfixed payload size and is determined based on the number of beams to report indicated by the indication in the Part 1. The first indicator is an example of the first indication. By reporting the beam report including two parts, the network device 120 first receives the Part 1, and after obtaining the number of the beams to be reported from the Part1, thus the network device 120 determined the payload size of the Part 2, which is beneficial to further blind detection of the network device 120.

In some embodiments, introduce an additional indication of the number of beams outputted by the AI model (or the number of beams to report). The indication is applied for the current beam report. The Part 1 includes fixed information, e.g., indication, and the Part 2 includes unfixed information, e.g., beam information. In some embodiments, the Part 1 contains only an indication of the number of beams to report. For example, if the indication in the Part 1 indicates that there are N beams to report. In some embodiments, the beam information includes CRI (CSI-RS resource indicator) of beams to report. In some embodiments, the beam information includes CRI and L1-RSRP of beams to report.

According to the example above, the payload size of the beam information in the Part 2 needs to be determined based on the total bitwidth for N beam information, e.g., N CRIs and N L1-RSRPs. That is, it can be determined based on the existing beam reporting, e.g., group-based beam reporting: N CRIs, 1 absolute L1-RSRP (e.g., occurs 7 bits) and N-1 differential L1-RSRPs (e.g., each one occurs 4 bits).

In some embodiments, CSI report carrying L1-RSRP, L1-SINR (layer 1 Signal to interference plus noise ratio), CRI or SSBRI (SSB resource indicator), or CSI report with report quantity of “cri-RSRP”, “ssb-Index-RSRP”, “cri-SINR” or “ssb-Index-SINR”, etc. In some embodiments, beam information may include beam ID and corresponding beam quality (L1-RSRP or L1-SINR).

With reference to FIG. 7, in some embodiments, the payload size (or bitwidth) of the first indicator can be determined based on one of the following information. In some embodiments, the number of CSI-RS (Channel state information reference signal)/SSB (Synchronization Signal and PBCH block) resources corresponding to (or configured with) the beam report. Specifically, the payload size can be determined based on the following formula:

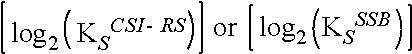

where K_{S}^{CSI-RS} is the number of the corresponding CSI-RS/SSB resources. For example, assuming K_{S}^{CSI-RS} equals to 64, the payload size of the first indicator occurs 6 bits. Further, “000000” means that there is 1 beam to report, “000001” means that there are 2 beams to report, and so on.

In some embodiments, the value of configured K corresponding to the beam report (If the K is not configured, it equals to 1). Specifically, the following formula can be adopted to determine the payload size:

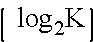

It means that the number of beams to report needs to be less than or equal to the value of K. For example, assuming K equals to 8, the payload size of the first indicator occurs 3 bits. Further, “000” means that there is 1 beam to report, “001” means that there are 2 beams to report, and so on. The value of the K depends on a new UE (User Equipment) capability (called as “first UE capability”). The first UE capability can refer to the maximum number of predicted beams outputted by the AI model.

In this way, the network device 120 can determine the value of K based on the first UE capability, for example, a value of the first UE capability is Nmax, thus, the network device 120 can determine the value of K that equals to or less than Nmax. Moreover, waste of resources is avoided because the resources is configured according the UE capability.

In some embodiments, assuming the first UE capability is represented by “Nmax”, the following formula can be adopted to determine the payload size:

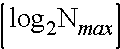

In this case, the payload size (or bitwidth) of the first indicator can be determined by the terminal device 110 based on the capability information.

In some embodiments, the beam report includes a first part and a second part, the first part includes the first indication and the beam information of one of the predicted beams, and the second part includes the beam information of the second number of the predicted beams.

In some embodiments, the terminal device 110 may determine the second number based on the first number indicated by the first indication. In these embodiments, the terminal device 110 may determine a payload size of the beam information in the first part based on a CSI-RS resource indicator (CRI) and an absolute reference signal received power (RSRP).

In these embodiments, the terminal device 110 may determine a payload size of the beam information in the second part based on the second number of CRIs and the second number of differential RSRPs. Accordingly, at the network device 120, in some embodiments, the network device 120 may determine the second number based on the first number indicated by the first indication.

At the network device 120, in some embodiments, the network device 120 may determine a payload size of the beam information in the first part based on a CSI-RS resource indicator (CRI) and an absolute reference signal received power (RSRP). In some embodiments, the network device 120 may determine a payload size of the beam information in the second part based on the second number of CRIs and the second number of differential RSRPs.

In some embodiments, the first part includes the first indication and the beam information of one of the predicted beams. In other words, in addition to the first indicator, the Part 1 may also contains the beam information of the best (predicted) beam, i.e., top 1 beam out of the predicted N beams. Meanwhile, the Part 2 contains the beam information of the other beams to report.

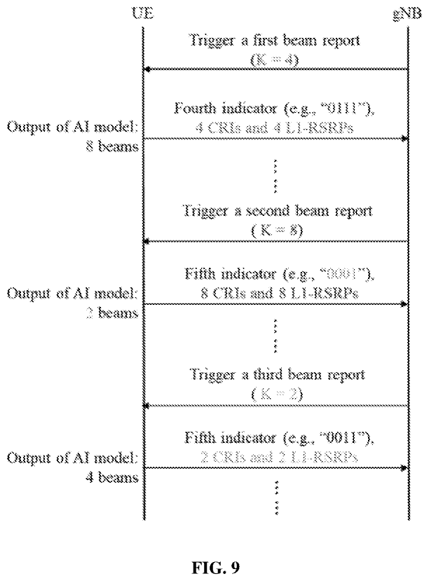

FIG. 8 illustrates another example of a schematic diagram of beam report composition. As shown in FIG. 8, in addition to the first indicator, the Part 1 also contains the beam information of the best (predicted) beam, i.e., top 1 beam out of the predicted N beams. Meanwhile, the Part 2 contains the beam information of the other beams to report. As shown in FIG. 8, the beam report comprises the Part 1 and the Part 2, and the Part 1 comprises first indicator and top 1 beam information, and the Part 2 comprises the other beam information. For short, “the beam information in the Part 1” and “the beam information in the Part 2” can be called as “the first beam info” and “the second beam info” respectively.

In some embodiments, top 1 beam (i.e., the predicted best beam) information comprises 1 CRI and 1 absolute L1-RSRP. The other beam information comprises N-1 CRIs and N-1 differential L1-RSRPs. Accordingly, the payload size of the first beam info can be determined based on 1 CRI and 1 absolute L1-RSRP, and the payload size of the second beam info can be determined based on N-1 CRI and N-1 differential L1-RSRP.

In some embodiments, especially for a P/SP (periodic or semi-persistent) beam report based on PUCCH, UE can only report the Part 1, i.e., only report the indication of the number of beams to report and the top 1 beam out of the predicted beams. Based on this method, the overhead of beam reporting can be saved; moreover, there is one beam available for the network device 120. Meanwhile, gNB can be guaranteed to receive at least one predicted best beam. Additionally, if the AI model outputs only one beam, UE can only report the Part 1.

In some embodiments, the beam report includes a first part and a second part, the first part includes the first indication and a third number of the predicted beams among the first number of the predicted beams, and the second part includes the beam information of the second number of beams.

In these embodiments, the terminal device 110 may determine the third number based on a value of the number of beams to be reported by the terminal device 110 configured by the network device 120, and may determine the second number based on the first number indicated by the first indication and the third number.

In these embodiments, the terminal device 110 may determine a payload size of the beam information in the first part based on the third number of CSI-RS resource indicators (CRIs), an absolute reference signal received power (RSRP) and differential RSRPs, the number of the differential RSRPs are equal to the third number minus one.

In these embodiments, the terminal device 110 may determine a payload size of the beam information in the second part based on the second number of CRIs and the second number of differential RSRPs. In these embodiments, the terminal device 110 may determine a payload size of the CRI in the second part based on the first number and the third number. Accordingly, at the network device 120, in some embodiments, the network device 120 may determine the third number based on a value of the number of beams to be reported by the terminal device 110 configured by the network device 120.

In some embodiments, the network device 120 may determine the second number based on the first number indicated by the first indication and the third number. In these embodiments, the network device 120 may determine a payload size of the beam information in the first part based on the third number of CSI-RS resource indicators (CRIs), an absolute reference signal received power (RSRP) and differential RSRPs, the number of the differential RSRPs are equal to the third number minus one. In these embodiments, the network device 120 may determine a payload size of the beam information in the second part based on the second number of CRIs and the second number of differential RSRPs.

In some embodiments, the network device 120 may determine a payload size of the CRI in the second part based on the first number and the third number. According to the above embodiments, the Part 1 can contain the beam information of the top M (e.g., 1<M<N) beams to report. The Part 2 contains the beam information of the other beams (e.g., N-M beams) to report. In this case, top M beam information comprises M CRIs, 1 absolute L1-RSRP and M-1 L1-RSRPs. The other beam information comprises N-M CRIs and N-M differential L1-RSRPs.

In some embodiments, in addition to the first indicator, the Part 1 also contains the beam information of the top M (M>=1) beam(s) out of the predicted N beams. Meanwhile, the Part 2 contains the beam information of the other beams (i.e., N-M beams) to report. Moreover, the value of the M can be determined based on that of the K. In this way, the number of beams to be reported can be determined by the network device 120. For example, the M can be equal to the configured K, e.g., higher layers configuration “nrofReportedRS”. If the K is not configured, it equals to 1. “nrofReportedRS” represents the number (N) of measured RS resources to be reported per report setting in a non-group-based report. N<N_max, where N_max is either 2 or 4 depending on UE capability (TS 38.214 [19], clause 5.2.1.4). When the field is absent the UE applies the value 1.

In some embodiments, the payload size of the first beam info can be determined based on K CRIs, 1 absolute L1-RSRP and K-1 differential L1-RSRPs. The payload size of the first beam info can be determined based on K CRIs, 1 absolute L1-RSRP and K-1 differential L1-RSRPs. Especially for CRI (i.e., CRI in Part 1), the corresponding payload size can be determined based on the following formula:

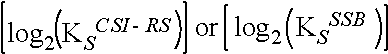

The payload size of the second beam info can be determined based on N-K CRIs, N-K differential L1-RSRPs. Especially for CRI (i.e., CRI in Part 2), the corresponding payload size can be determined based on the following formula:

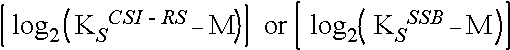

In this case, the first indicator can be used to indicate the number of beams to report in Part 2. And the corresponding payload size can be determined according to the one of the following formulas:

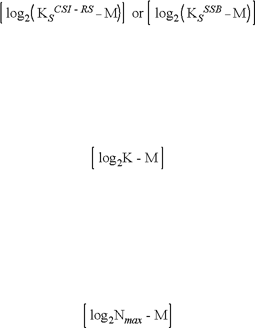

In some embodiments, the beam report is the first beam report of a plurality of periodic or semi-persistent (P/SP) beam reports, and the second number is determined based on a value of the number of beams to be reported by the terminal device 110 configured by the network device 120.

In some embodiments, the beam report is a beam report of a plurality of periodic or semi-persistent beam reports, and the terminal device 110 may determine the second number based on the first number indicated by the first indication in a recent beam report has been reported. Accordingly, at the network device 120, the network device 120 may determine the second number based on the first number indicated by the first indication in a recent beam report has been reported.

In some embodiments, the beam report is a beam report of a plurality of periodic or semi-persistent beam reports satisfying an offset and a period configured by the network device 120, and the beam report includes the first indication and the beam information of the second number of the predicted beams. In some embodiments, the beam report is a beam report of a plurality of periodic or semi-persistent beam reports not satisfying an offset and a period configured by the network device 120, and the beam report includes only the beam information of the second number of the predicted beams.

Specifically, UE may report to gNB an indication of the predicted beams outputted by the AI model, wherein the indication is applied for the next one or multiple beams report. In this case, legacy beam reporting can be reused. In some embodiments, the indication can be used as a recommend value of the K to assist gNB in configuring the value of the K, in other words, the K depends on the information indicated by the indication.

FIG. 9 illustrates an example of a signaling chart for beam reporting between terminal device 110 and network device 120. Although the indication (called as “fourth indicator”) is reported in the current beam report (called as “first beam report”), the information indicated by the fourth indicator is not applied to the first beam report, but to another beam report (called as “second beam report”), and for example, next or later beam report.

In some embodiments, similar to the first indicator, the fourth indicator can be reported together with CRI and L1-RSRP, and its payload size can be determined based on the method described in the previous embodiment. The introduction of the fourth indicator can be regarded as an extension of the legacy beam reporting. For example shown in FIG. 9, assuming the fourth indicator occupies 4 bits.

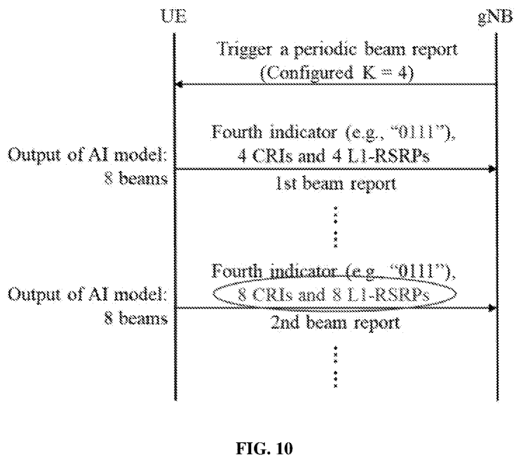

For legacy beam reporting, After UE is trigger with a P (Periodic)/SP (semi-persistent)/AP (Aperiodic) beam report, UE shall report to gNB the beam IDs and beam qualities corresponding to the top K beams. K is configured by gNB through RRC signaling. If UE is not configured with K, then the K equals to 1. In some situation, especially for P/SP beam report, the number of beams to report cannot be reconfigured or indicated dynamically for each beam report. FIG. 10 illustrates another example of a signaling chart for beam reporting between terminal device 110 and network device 120.

As shown in FIG. 10, K=4 is configured by the gNB, but when the number of the beams to be reported need to be changed to 8, how to determine the number of beams to report is to be solved. To reconfigure the K, due to signaling delay and other reasons, it takes a long time, for example, the delay may reach 10 ms.

In some embodiments, one solution to the above problem is that UE/gNB can apply the number of beams to report indicated by the fourth indicator in the first beam report for the second beam report. It also means that the number of beams to report may not depend on the value of the K. For example, in some embodiments, the number of beams to report indicated by the fourth indicator is applied for next one beam report. For example, in some other embodiments, the number of beams to report indicated by the fourth indicator is applied for next multiple beam reports.

In some embodiments, another solution to the above problem is that introduce a new DL (down link) indication of the number of beams to report, i.e., supporting dynamic indication of the K. For example, in some other embodiments, introduce a (new or legacy) DCI (Downlink control information) or DL MAC-CE (Media access control-control element) to indicate the number of beams to report. The following will introduce the above two solutions and their specific implementation according to specific examples.

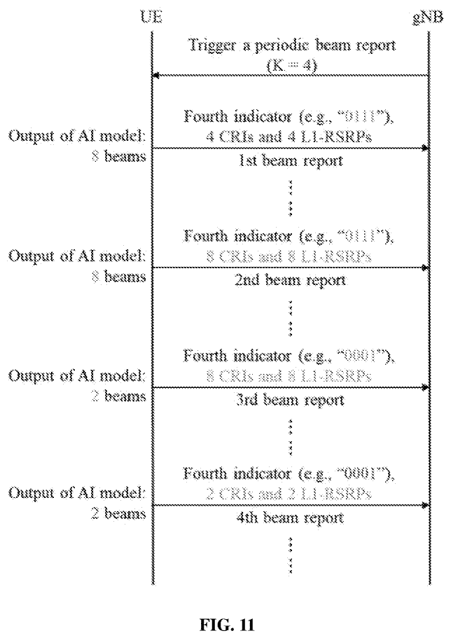

FIG. 11 illustrates a further example of a signaling chart for beam reporting between terminal device 110 and network device 120. As shown in FIG. 11, the number of beams to report indicated by the fourth indicator is applied for next one beam report.

In some embodiments, for each P/SP beam report, UE needs to report the fourth indicator and beam information. At least for the first P/SP beam report, UE needs to determine the number of beams to report based on the configured K. For the other P/SP beam reports, UE can determine the number of beams to report based on the information indicated by the fourth indicator reported in the recent beam report.

In some embodiments, if the number of the predicted beams outputted by the AI model is less than 8, it can be considered to perform zero filling. For example, if the AI model outputs 2 beams and the base station reserves 8 beams of resources, then if there are not 6 beams to report, the reserved resources corresponding to the 6 beams will be supplemented by 0. In some embodiments, if the number of the predicted beams outputted by the AI model is larger than 8 and the base station reserves 8 beams of resources, it can be considered to report the top 8 beams out of the predicted beams.

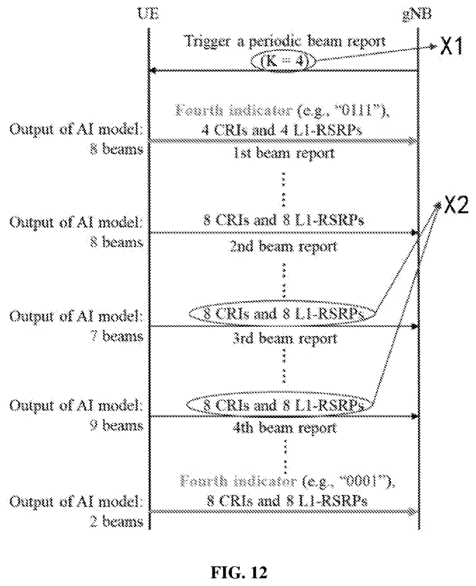

FIG. 12 illustrates a still further example of a signaling chart for beam reporting between terminal device 110 and network device 120. As shown in FIG. 12, the number of beams to report indicated by the fourth indicator is applied for next multiple beam reports.

In some embodiments, for example, UE can be configured with a new (starting) offset and a new period (e.g., time unit: symbol, slot, ms or s) dedicated for reporting the fourth indicator (configured by RRC (Radio Resource Control)). Optionally, the offset of the P/SP beam report can be reused as the new offset.

In some embodiments, at least for the P/SP beam reports in the time domains corresponding to the new offset and new period, UE needs to report the fourth indicator and beam information. For the other P/SP beam reports, UE does not needs to report the fourth indicator and does need only to report the beam information.

In some embodiments, at least for the first P/SP beam report, UE needs to determine the number of beams to report based on the configured K. For the other P/SP beam reports, UE can determine the number of beams to report based on the information indicated by the fourth indicator reported in the recent beam report.

As shown at X1, as initial number of the beams to report, e.g., it is only applied for the first beam report. As shown at X2, if the number of the predicted beams outputted by the AI model is less than 8, it can be considered to perform zero filling. If the number of the predicted beams outputted by the AI model is larger than 8, it can be considered to report the top 8 beams out of the predicted beams.

In these embodiments, the indication reported in a beam report is applied for the other one beam report or some other beam reports, and the indication can also be used as assistance information of K. especially in some embodiments, for P/SP beam report, dynamic configuration/indication of K can be realized explicitly or implicitly.

In some embodiments, the network device 120 may transmit, to the terminal device 110, a control signaling indicating the number of beams to be reported by the terminal device 110. In these embodiments, the beam report may be a beam report of a plurality of periodic or semi-persistent beam reports. In some embodiments, the terminal device 110 may determine the second number based on the number of beams to be reported by the terminal device 110 indicated by the control signaling transmitted by the network device 120.

Accordingly, at the network device 120, the network device 120 may determine the second number based on the number of beams to be reported by the terminal device 110 indicated by the control signaling. In these embodiments, the beam report may be a beam report of a plurality of periodic or semi-persistent beam reports.

In some embodiments, the control signaling may be downlink control information (DCI) or a downlink (DL) medium access control (MAC)-control element (CE). In some embodiments, a CSI request field in the DCI indicates an aperiodic trigger state associated with the beam report. In some embodiments, the DCI is scrambled with a radio network temporary identifier (RNTI) indicating that the DCI includes a value of the number of beams to be reported by the terminal device 110 configured by the network device 120. In some embodiments, the MAC-CE includes an identifier of the second number.

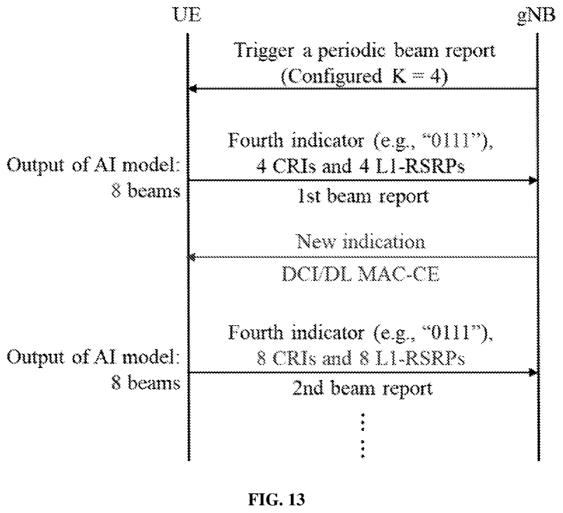

With reference to FIG. 13, which illustrates a yet further example of a signaling chart for beam reporting between terminal device 110 and network device 120. As shown in FIG. 13, in some embodiments, introduce a new indication, for example DCI or DL MAC-CE, to indicate the number of beams to report. After UE receives the new indication, the number of beams to report corresponding to the next one beam report indicated by the new indication is determined based on the information (e.g., the value of K) indicated by the new indication.

In some embodiments, gNB can use the “CSI request” filed in DCI to indicate an AP trigger state associated with the (ID of the) JIM beam report. Further, the DCI may be scrambled with a new RNTI (Radio network temporary identity). In other embodiments, gNB can use a new MAC-CE comprising at least the ID or index of the beam report and the number of beams to report.

In some embodiments, after UE receives the new indication, the number of beams to report corresponding to the next multiples beam reports indicated by the new indication is determined based on the information indicated by the new indication. And UE does not use the newly indicated number of beams to report until another new indication is received. In this way, when the number of the beams to be reported, for example K, needs to be reconfigured, the time delay of K reconfiguration can be reduced.

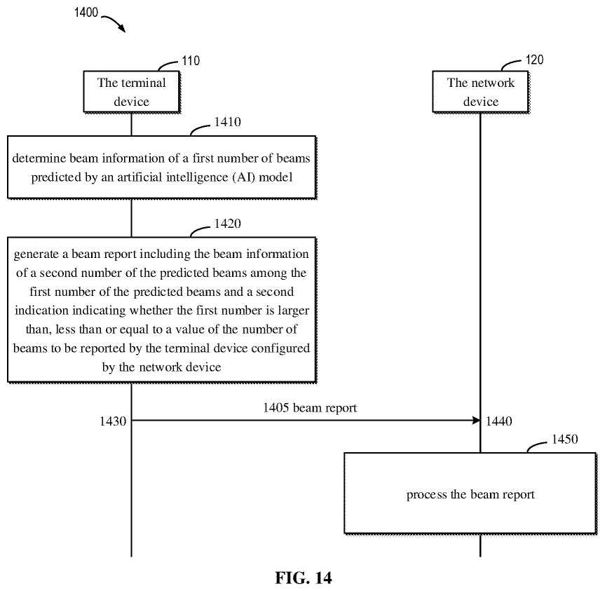

FIG. 14 illustrates a schematic diagram illustrating a process 1400 for communication between a terminal device 110 and a network device 120. As shown in FIG. 14, the terminal device 110 may determine (1410) beam information of a first number of beams predicted by an artificial intelligence (AI) model, and the terminal device 110 may generate (1420), a beam report (1405) including the beam information of a second number of the predicted beams among the first number of the predicted beams and a second indication indicating whether the first number is larger than, less than or equal to a value of the number of beams to be reported by the terminal device 110 configured by the network device 120, and then the terminal device 110 may transmit (1430) the beam report (1405) to a network device 120.

Accordingly, at the network device 120, the network device 120 may receiving (1440), at a network device 120 from a terminal device 110, a beam report (1405) including beam information of a second number of predicted beams among a first number of predicted beams predicted by an artificial intelligence (AI) model and a second indication indicating whether the first number is larger than, less than or equal to a value of the number of beams to be reported by the terminal device 110 configured by the network device 120, and then the network device 120 may process (1450) the beam report (1405).

FIG. 15 illustrates an example of signalling chart for beam reporting between terminal device 110 and network device 120. As shown in FIG. 15, UE reports to gNB an indication (called as “fifth indicator”) indicating whether the number of beams outputted or predicted by the AI model is larger than a predefined threshold (e.g., the value of K).

In some embodiments, the information indicated by the fifth indicator in the first beam report is applied to the second beam report. In some embodiments, the fifth indicator can be a part of beam report, and it can be reported together with CRI and L1-RSRP. In some embodiments, the payload size of the fifth indicator can be 1 bit. e.g., for the reported fifth indicator, “1” refers to the number of beams outputted the AI model is larger than the value of the K, “0” refers to the number of beams outputted the AI model is less than or equal to the value of the K.

In some embodiments, the payload size of the fifth indicator can be 2 bits, e.g., “10” refers to the number of beams outputted the AI model is larger than the value of the K, “01” refers to the number of beams outputted the AI model is less than the value of the K, “00” refers to the number of beams outputted the AI model is equal to the value of the K.

In some embodiments, assuming the value of the K is 4. For the triggered first beam report, the AI model outputs (the top) 4 beams. The fifth indicator is should be “0” because the number of outputted beams is equal to K. In this case, beam reporting can be performed based on the existing spec (i.e., legacy beam reporting). For the triggered second beam report, the AI model outputs 8 beams. UE may not be configured with the K. In this case, beam reporting can be performed based on that the beam report includes the Part 1 and the Part 2. For the fifth indicator, it is should be “1” because the number of outputted beams is larger than K. For the triggered third beam report, the AI model outputs 7 beams, so the fifth indicator should be “1”. And the beam reporting is still performed based on that the beam report includes the Part 1 and the Part 2.

In these embodiments, switching between reporting the beam report in a conventional manner and reporting the beam report in two parts (for example, Part 1+Part 2) can be realized, thus the network device 120 can select a form of beam reporting based on the comparison result between the number of beams outputted by the AI model and a value of the number of beams to be reported by the terminal device 110 determined by network device 120. In this way, UE/gNB can be assisted to determine which of the following method is used: legacy beam reporting or beam reporting in a form of including Part 1 and Part 2.

According the embodiments of the present disclosure, it is benefit to determine the actual best beam, and it is benefit to determine, verify or check the (generalization) performance of AI model, and it is benefit to save the overhead of beam reporting potentially.

In summary, embodiments of the present disclosure may provide the following solutions.

A method for communication, comprises: determining, at a terminal device, beam information of a first number of beams predicted by an artificial intelligence (AI) model; generating, a beam report including a first indication of the first number and the beam information of a second number of the predicted beams among the first number of the predicted beams; and transmitting the beam report to a network device.

In one embodiment, the method as above further comprises: determining a payload size of the first indication based on one of: the number of channel state information reference signal (CSI-RS) or synchronization signal and PBCH block (SSB) resources corresponding to the beam report, a value of the number of beams to be reported by the terminal device configured by the network device, and capability information of the terminal device indicating a maximum number of beams predicted by the AI model.

In one embodiment, the method as above, wherein the value is determined by the network device based on the capability information of the terminal device.

In one embodiment, the method as above, wherein: the beam report includes a first part and a second part, the first part includes the first indication, and the second part includes the beam information of the second number of the predicted beams.

In one embodiment, the method as above, wherein: the beam report includes a first part and a second part, the first part includes the first indication and the beam information of one of the predicted beams, and the second part includes the beam information of the second number of the predicted beams.

In one embodiment, the method as above further comprises: determining the second number based on the first number indicated by the first indication.

In one embodiment, the method as above further comprises at least one of: determining a payload size of the beam information in the first part based on a CSI-RS resource indicator (CRI) and an absolute reference signal received power (RSRP), and determining a payload size of the beam information in the second part based on the second number of CRIs and the second number of differential RSRPs.

In one embodiment, the method as above, wherein: the beam report includes a first part and a second part, the first part includes the first indication and a third number of the predicted beams among the first number of the predicted beams, and the second part includes the beam information of the second number of beams.

In one embodiment, the method as above further comprises: determining the third number based on a value of the number of beams to be reported by the terminal device configured by the network device; and determining the second number based on the first number indicated by the first indication and the third number.

In one embodiment, the method as above further comprises at least one of: determining a payload size of the beam information in the first part based on the third number of CSI-RS resource indicators (CRIs), an absolute reference signal received power (RSRP) and differential RSRPs, the number of the differential RSRPs are equal to the third number minus one, and determining a payload size of the beam information in the second part based on the second number of CRIs and the second number of differential RSRPs.

In one embodiment, the method as above further comprises: determining a payload size of the CRI in the second part based on the first number and the third number.

In one embodiment, the method as above, wherein the beam report is the first beam report of a plurality of periodic or semi-persistent beam reports, and the second number is determined based on a value of the number of beams to be reported by the terminal device configured by the network device.

In one embodiment, the method as above, wherein the beam report is a beam report of a plurality of periodic or semi-persistent beam reports, and the method further comprises: determining the second number based on the first number indicated by the first indication in a recent beam report has been reported.

In one embodiment, the method as above, wherein the beam report is a beam report of a plurality of periodic or semi-persistent beam reports satisfying an offset and a period configured by the network device, and the beam report includes the first indication and the beam information of the second number of the predicted beams.

In one embodiment, the method as above, wherein the beam report is a beam report of a plurality of periodic or semi-persistent beam reports not satisfying an offset and a period configured by the network device, and the beam report includes only the beam information of the second number of the predicted beams.

In one embodiment, the method as above further comprises: determining the second number based on the number of beams to be reported by the terminal device indicated by a control signaling transmitted by the network device.

In one embodiment, the method as above, wherein the control signaling is downlink control information (DCI) or a downlink (DL) medium access control (MAC)-control element (CE).

In one embodiment, the method as above, wherein at least one of: a CSI request field in the DCI indicates an aperiodic trigger state associated with the beam report, the DCI is scrambled with a radio network temporary identifier (RNTI) indicating that the DCI includes a value of the number of beams to be reported by the terminal device configured by the network device, and the MAC-CE includes an identifier of the second number.

In one embodiment, the method as above, wherein the beam report is a beam report of a plurality of periodic or semi-persistent beam reports.

A method for communication, comprises: determining, at a terminal device, beam information of a first number of beams predicted by an artificial intelligence (AI) model;

generating, a beam report including the beam information of a second number of the predicted beams among the first number of the predicted beams and a second indication indicating whether the first number is larger than, less than or equal to a value of the number of beams to be reported by the terminal device configured by the network device; and transmitting the beam report to a network device.

A method for communication comprises: receiving, at a network device from a terminal device, a beam report including a first indication of a first number and beam information of a second number of the predicted beams among the first number of the predicted beams, the predicted beams being predicted by an artificial intelligence (AI) model; and processing the beam report.

In one embodiment, the method as above further comprises: determining, based on the first number indicated by the first indication, a value of the number of beams to be reported by the terminal device.

In one embodiment, the method as above further comprises: determining a payload size of the first indication based on one of: the number of channel state information reference signal (CSI-RS) or synchronization signal and PBCH block (SSB) resources corresponding to the beam report, a value of the number of beams to be reported by the terminal device configured by the network device, and capability information of the terminal device indicating a maximum number of beams predicted by the AI model.

In one embodiment, the method as above further comprises: receiving the capability information of the terminal device; and determining the value based on the capability information of the terminal device.

In one embodiment, the method as above, wherein: the beam report includes a first part and a second part, the first part includes the first indication, and the second part includes the beam information of the second number of the predicted beams.

In one embodiment, the method as above, wherein: the beam report includes a first part and a second part, the first part includes the first indication and the beam information of one of the predicted beams, and the second part includes the beam information of the second number of the predicted beams.

In one embodiment, the method as above further comprises: determining the second number based on the first number indicated by the first indication.

In one embodiment, the method as above further comprises at least one of: determining a payload size of the beam information in the first part based on a CSI-RS resource indicator (CRI) and an absolute reference signal received power (RSRP), and determining a payload size of the beam information in the second part based on the second number of CRIs and the second number of differential RSRPs.

In one embodiment, the method as above, wherein: the beam report includes a first part and a second part, the first part includes the first indication and a third number of the predicted beams among the first number of the predicted beams, and the second part includes the beam information of the second number of beams.

In one embodiment, the method as above further comprises: determining the third number based on a value of the number of beams to be reported by the terminal device configured by the network device; and determining the second number based on the first number indicated by the first indication and the third number.

In one embodiment, the method as above further comprises at least one of: determining a payload size of the beam information in the first part based on the third number of CSI-RS resource indicators (CRIs), an absolute reference signal received power (RSRP) and differential RSRPs, the number of the differential RSRPs are equal to the third number minus one, and determining a payload size of the beam information in the second part based on the second number of CRIs and the second number of differential RSRPs.

In one embodiment, the method as above further comprises: determining a payload size of the CRI in the second part based on the first number and the third number.

In one embodiment, the method as above, wherein the beam report is the first beam report of a plurality of periodic or semi-persistent beam reports, and the second number is determined based on a value of the number of beams to be reported by the terminal device configured by the network device.

In one embodiment, the method as above, wherein the beam report is a beam report of a plurality of periodic or semi-persistent beam reports, and the method further comprises: determining the second number based on the first number indicated by the first indication in a recent beam report has been reported.

In one embodiment, the method as above, wherein the beam report is a beam report of a plurality of periodic or semi-persistent beam reports satisfying an offset and a period configured by the network device, and the beam report includes the first indication and the beam information of the second number of the predicted beams.

In one embodiment, the method as above, wherein the beam report is a beam report of a plurality of periodic or semi-persistent beam reports not satisfying an offset and a period configured by the network device, and the beam report includes only the beam information of the second number of the predicted beams.

In one embodiment, the method as above further comprises: transmitting, to the terminal device, a control signaling indicating the number of beams to be reported by the terminal device.

In one embodiment, the method as above further comprises: determining the second number based on the number of beams to be reported by the terminal device indicated by the control signaling.

In one embodiment, the method as above, wherein the control signaling is downlink control information (DCI) or a downlink (DL) medium access control (MAC)-control element (CE).

In one embodiment, the method as above, wherein at least one of: a CSI request field in the DCI indicates an aperiodic trigger state associated with the beam report, the DCI is scrambled with a radio network temporary identifier (RNTI) indicating that the DCI includes a value of the number of beams to be reported by the terminal device configured by the network device, and the MAC-CE includes an identifier of the second number.

In one embodiment, the method as above, wherein the beam report is a beam report of a plurality of periodic or semi-persistent beam reports.

A method for communication, comprises: receiving, at a network device from a terminal device, a beam report including beam information of a second number of predicted beams among a first number of predicted beams predicted by an artificial intelligence (AI) model and a second indication indicating whether the first number is larger than, less than or equal to a value of the number of beams to be reported by the terminal device configured by the network device; and processing the beam report.

A terminal device comprises: a processor; and a memory storing computer program codes; the memory and the computer program codes configured to, with the processor, cause the terminal device to perform the method for communication as above.

A network device comprises: a processor; and a memory storing computer program codes; the memory and the computer program codes configured to, with the processor, cause the network device to perform the method for communication as above.

A computer readable medium having instructions stored thereon, the instructions, when executed by a processor of an apparatus, causing the apparatus to perform the method for communication as above.

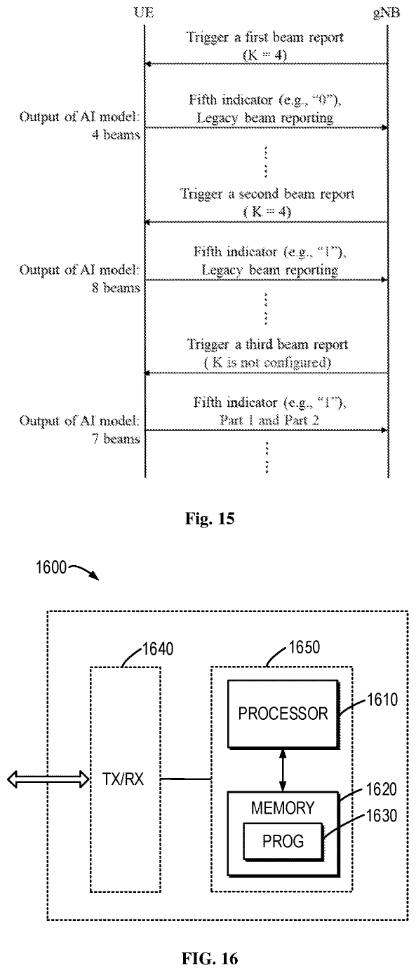

FIG. 16 illustrates a simplified block diagram of a device 1600 that is suitable for implementing embodiments of the present disclosure. The device 1600 can be considered as a further example implementation of the terminal device 110 and/or the network device 120 as shown in FIG. 1. Accordingly, the device 1600 can be implemented at or as at least a part of the terminal device 110 or the network device 120.

As shown, the device 1600 includes a processor 1610, a memory 1620 coupled to the processor 1610, a suitable transmitter (TX) and receiver (RX) 1640 coupled to the processor 1610, and a communication interface coupled to the TX/RX 1640. The memory 1610 stores at least a part of a program 1630. The TX/RX 1640 is for bidirectional communications. The TX/RX 1640 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1630 is assumed to include program instructions that, when executed by the associated processor 1610, enable the device 1600 to operate in accordance with the embodiments of the present disclosure, as discussed herein with reference to FIGS. 3-15. The embodiments herein may be implemented by computer software executable by the processor 1610 of the device 1600, or by hardware, or by a combination of software and hardware. The processor 1610 may be configured to implement various embodiments of the present disclosure. Furthermore, a combination of the processor 1610 and memory 1620 may form processing means 1650 adapted to implement various embodiments of the present disclosure.

The memory 1620 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1620 is shown in the device 1600, there may be several physically distinct memory modules in the device 1600. The processor 1610 may be of any type suitable to the local technical network, and may include one or more of general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-15. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communication, comprising:
determining, at a terminal device, beam information of a first number of beams predicted by an artificial intelligence (AI) model;
generating, a beam report including a first indication of the first number and the beam information of a second number of the predicted beams among the first number of the predicted beams; and
transmitting the beam report to a network device.

2. The method of claim 1, further comprising:
determining a payload size of the first indication based on one of:
the number of channel state information reference signal (CSI-RS) or synchronization signal and PBCH block (SSB) resources corresponding to the beam report,
a value of the number of beams to be reported by the terminal device configured by the network device, and
capability information of the terminal device indicating a maximum number of beams predicted by the AI model.

3. The method of claim 2, wherein the value is determined by the network device based on the capability information of the terminal device.

4. The method of claim 1, wherein:
the beam report includes a first part and a second part, the first part includes the first indication, and the second part includes the beam information of the second number of the predicted beams.

5. The method of claim 1, wherein:
the beam report includes a first part and a second part, the first part includes the first indication and the beam information of one of the predicted beams, and the second part includes the beam information of the second number of the predicted beams.

6. The method of claim 4 or 5, further comprising:
determining the second number based on the first number indicated by the first indication.

7. The method of claim 5, further comprising at least one of:
determining a payload size of the beam information in the first part based on a CSI-RS resource indicator (CRI) and an absolute reference signal received power (RSRP), and
determining a payload size of the beam information in the second part based on the second number of CRIs and the second number of differential RSRPs.

8. The method of claim 1, wherein:
the beam report includes a first part and a second part, the first part includes the first indication and a third number of the predicted beams among the first number of the predicted beams, and the second part includes the beam information of the second number of beams.

9. The method of claim 8, further comprising:
determining the third number based on a value of the number of beams to be reported by the terminal device configured by the network device; and
determining the second number based on the first number indicated by the first indication and the third number.

10. The method of claim 8 or 9, further comprising at least one of:
determining a payload size of the beam information in the first part based on the third number of CSI-RS resource indicators (CRIs), an absolute reference signal received power (RSRP) and differential RSRPs, the number of the differential RSRPs are equal to the third number minus one, and
determining a payload size of the beam information in the second part based on the second number of CRIs and the second number of differential RSRPs.

11. The method of claim 10, further comprising:
determining a payload size of the CRI in the second part based on the first number and the third number.

12. The method of claim 1, wherein the beam report is the first beam report of a plurality of periodic or semi-persistent beam reports, and the second number is determined based on a value of the number of beams to be reported by the terminal device configured by the network device.

13. The method of claim 1, wherein the beam report is a beam report of a plurality of periodic or semi-persistent beam reports, and the method further comprising:
determining the second number based on the first number indicated by the first indication in a recent beam report has been reported.

14. The method of claim 1, wherein the beam report is a beam report of a plurality of periodic or semi-persistent beam reports satisfying an offset and a period configured by the network device, and the beam report includes the first indication and the beam information of the second number of the predicted beams.

15. The method of claim 1, wherein the beam report is a beam report of a plurality of periodic or semi-persistent beam reports not satisfying an offset and a period configured by the network device, and the beam report includes only the beam information of the second number of the predicted beams.

16. The method of claim 1, further comprising:
determining the second number based on the number of beams to be reported by the terminal device indicated by a control signaling transmitted by the network device.

17. The method of claim 16, wherein the control signaling is downlink control information (DCI) or a downlink (DL) medium access control (MAC)-control element (CE).

18. The method of claim 17, wherein at least one of:
a CSI request field in the DCI indicates an aperiodic trigger state associated with the beam report,
the DCI is scrambled with a radio network temporary identifier (RNTI) indicating that the DCI includes a value of the number of beams to be reported by the terminal device configured by the network device, and
the MAC-CE includes an identifier of the second number.

19. The method of claim 16, wherein the beam report is a beam report of a plurality of periodic or semi-persistent beam reports.

20. A method for communication, comprising:
determining, at a terminal device, beam information of a first number of beams predicted by an artificial intelligence (AI) model;
generating, a beam report including the beam information of a second number of the predicted beams among the first number of the predicted beams and a second indication indicating whether the first number is larger than, less than or equal to a value of the number of beams to be reported by the terminal device configured by the network device; and
transmitting the beam report to a network device.

21. A method for communication, comprising:
receiving, at a network device from a terminal device, a beam report including a first indication of a first number and beam information of a second number of the predicted beams among the first number of the predicted beams, the predicted beams being predicted by an artificial intelligence (AI) model; and
processing the beam report.

22. The method of claim 21, further comprising:
determining, based on the first number indicated by the first indication, a value of the number of beams to be reported by the terminal device.
